(19) United States
(12) Patent Application Publication
(10) Pub. No.: US 2015/0236399 A1
(43) Pub. Date: Aug. 20, 2015

(54) Image Capturing Device Having Printed Antenna

(71) Applicant: Smart Approach Co., Ltd., Hsinchu County (TW)

(72) Inventor: Hsin-Lung Lin, Hsinchu County (TW)

(21) Appl. No.: 14/534,302

(22) Filed: Nov. 6, 2014

(30) Foreign Application Priority Data
Feb. 17, 2014 (TW) 103105167
Jul. 14, 2014 (TW) 103124081

(51) Int. Cl. H01Q 1/22; H01Q 1/50; H04N 5/238; H01Q 1/38

(52) U.S. Cl. CPC H01Q 1/22; H01Q 1/38; H01Q 1/50; H04N 5/238

(57) ABSTRACT

An image capturing device having an antenna includes a lens module and a first circuit board. The first circuit board includes a printed antenna and a first transmitting port. The lens module is configured to capturing at least an image data, and the lens module is electrically connected to the first circuit board. The printed antenna is disposed on the surface of the first circuit board. The printed antenna is configured to receive a signal, and transmits the signal to the first transmitting port via the circuit of the first circuit board. The first circuit board is configured to transmit the signal and the image data. The first transmitting port is configured to transmit the signal and the image data out.

### BACKGROUND OF THE INVENTION

1. Field of the Invention

The invention relates to an image capturing device, and more particularly relates to an image capturing device having printed antenna.

2. Description of the Prior Art

Mobile electrical devices such as mobile phone or tablet PC had been a part of human life. These mobile electrical devices are smaller, cheaper, and more convenient than traditional mobile electrical device. For example, photography is a basic function of modern mobile electrical devices for device users to capturing and record interesting images by the mobile electrical device anytime. The recorded images can be shared with family and friends of users via internet. It now becomes a popular pastime in the modern society.

Besides photography and phoning, modern mobile phones have other functions such as position locating by GPS, sharing files through Bluetooth, surfing the internet via Wi-Fi, etc. For achieving said functions, the mobile phones need more antennas mounted therein to receive signals of different frequencies. Therefore, more numbers of antennas shall be mounted as the mobile phone has more and more functions. However, mounting more antennas in the mobile phone will result in increasing volume and complex assembly process.

Therefore, how to design an antenna arrangement to make electronic devices to be installed with variety of antennas without increasing volume and manufacturing cost is worth considering to a person having ordinary skills in the art.

### SUMMARY OF THE INVENTION

One object of the present invention is to provide an image capturing device having an antenna. The image capturing device having an antenna includes a circuit board, a lens module, and a printed antenna. The lens module and the printed antenna are disposed on the circuit board, and the lens module is surrounded by the printed antenna. Therefore, the volume of the image capturing device having an antenna can be decreased or minimized. In other words, the volume of mobile electronic device would not be increased even if the image capturing device having an antenna is mounted therein.

In addition, the printed antenna is disposed adjacent to the lens module, so during assembly process where the image capturing device having an antenna is assembled, the printed antenna and the lens are also assembled simultaneously. Therefore, the assembly process of the mobile electronic device can be faster, cheaper, and easier.

In summary, since the volume occupied by lens module and printed antenna in the mobile electronic device can be effectively reduced, the difficulty of installing antenna in the mobile electronic device can be solved. Besides, the image capturing device also can be designed as an add-on device, so old mobile electronic devices can obtain photography feature and ability of receiving various signals via the add-on image capturing device having an antenna.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 shows an explosion diagram of the image capturing device having an antenna.

FIG. 2A shows a top view of the image capturing device having an antenna of this embodiment.

FIG. 2B shows a detailed architecture chart of the signal processor.

FIG. 3 shows an element architecture chart of the image capturing unit.

FIG. 4 shows a lateral view of the image capturing device having an antenna of other embodiment.

FIG. 5A shows first circuit board.

FIG. 5B shows a detailed architecture chart of the signal processor.

FIG. 6 shows an element architecture chart of the capturing unit.

FIG. 7 shows an assembly method of the image capturing device having an antenna of present invention.

### DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

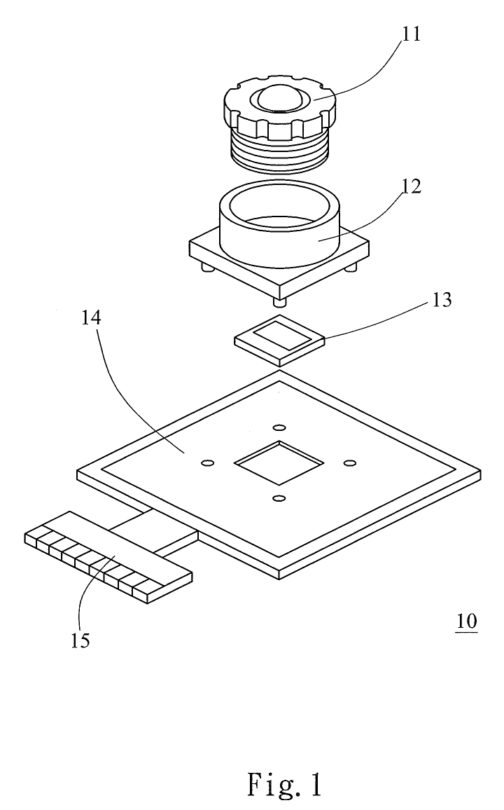

Please refer to FIG. 1. FIG. 1 shows an explosion diagram of the image capturing device 10 having an antenna. The image capturing device 10 having an antenna includes a lens module, a first circuit board 14 and a first transmitting port 15. The lens module includes a lens 11, a lens holder 12 and an image capturing unit 13. The first circuit board 14 further includes a printed antenna 16. The lens 11 is configured to capturing light via optical refraction. The lens holder 12 is disposed on the first circuit board 14 and used to hold the lens 11 in position for preventing shaking.

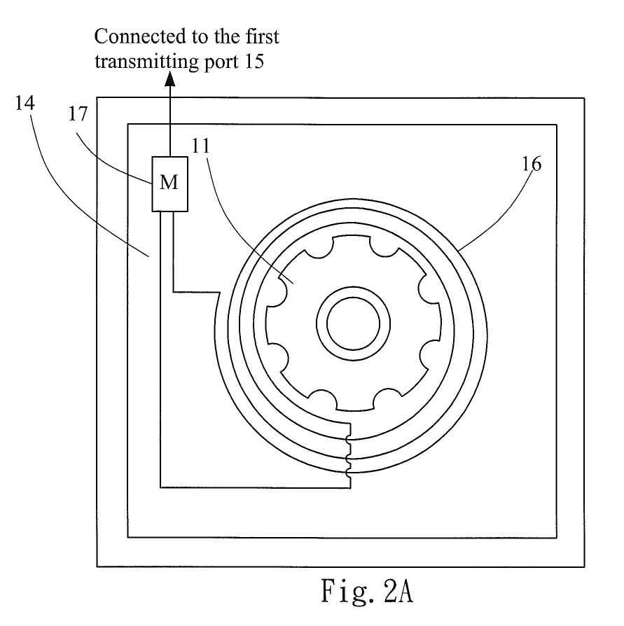

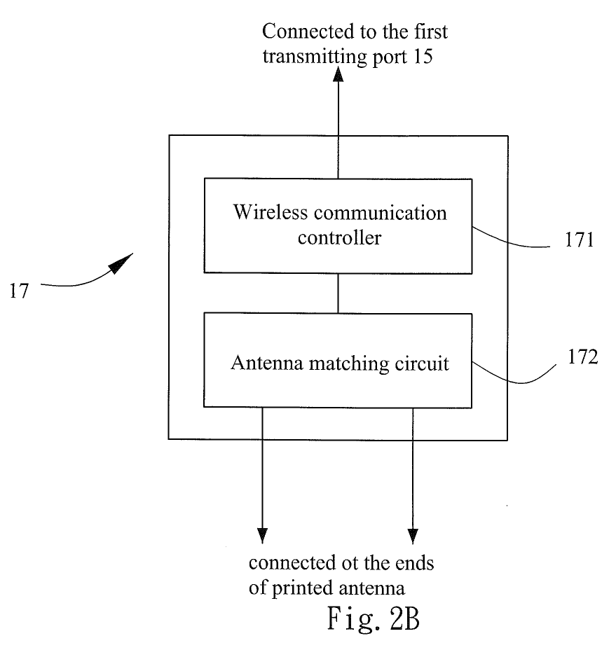

In addition, the image capturing unit 13 is disposed between the lens 11 and first circuit board 14, and the image capturing unit 13 is connected to the first circuit board 14 via a wire (not drawn in FIG. 1). Light capturing by lens 11 is transformed into digital image data by the image capturing unit 13. The image data is transmitted to the first circuit board 14 via the wire, and the image data is transmitted to the first transmitting port 15 by the circuit of the first circuit board 15. Then, the image data is transmitted out by the first transmitting port 15. For example, the image data is transmitted to a storage space of a handheld device (such as a mobile phone), and the image data is processed by the CPU of the handheld device. In this embodiment, the first circuit board 14 can be a flexible circuit board. Please refer to FIG. 2A. The FIG. 2A shows a top view of the image capturing device 10 having an antenna of this embodiment. In order to clearly express the location of the printed antenna 16, only the printed antenna 16, the lens 11, the first circuit board 14, the printed antenna 16 and the signal processor 17 are drawn in the FIG. 2A. The printed antenna 16 is disposed on the first circuit board 14 and is spiral-shaped. The lens 11 is surrounded by the printed antenna 16. The printed antenna 16 is connected to the signal processor 17, and the signal processor 17 is connected to the first transmitting port 15 via the circuit of the first circuit board 14. In this embodiment, the signal processor 17 is disposed on the first circuit board 14, but a person having ordinary skills in the art should understand, the signal processor 17 is not limited to being disposed on the circuit board. The signal processor 17 also can be disposed in other locations of the mobile device or on the second circuit board 37 of other embodiment of the present invention. In addition, the printed antenna 16 is configured to receive wireless signals conforming the specification of Near Field Communication (NFC) standard.

Please refer to FIG. 2B. FIG. 2B shows a detailed architecture chart of the signal processor 17. The signal processor 17 includes a wireless communication controller 171 and an antenna matching circuit 172. An analog signal received by the printed antenna 16 can be transformed to a digital signal by the wireless communication controller 171, so the signal can be transmitted out successfully from the first transmitting port 15. Beside, a digital signal can be transformed to an analog signal by the wireless communication controller 171, so the printed antenna 16 can exchange the signal with other antennas. The antenna matching circuit 172 is used for impedance matching and can reduce the impedance difference within the antenna, so the antenna matching circuit 172 can make signal transmitting more stable.

The image capturing device 10 having an antenna of this embodiment can be disposed in a mobile device such as a tablet PC or a mobile phone, etc. Therefore, the user of the mobile device can use the functions involving NFC standard, for example: electronic wallet, electronic ticket or exchanging file with other user.

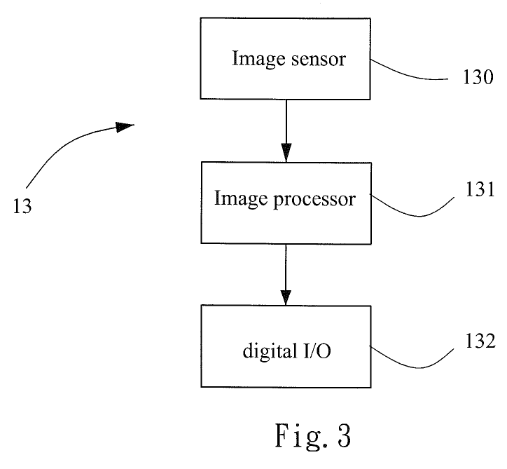

Please refer to FIG. 3. FIG. 3 shows an element architecture chart of the image capturing unit 13. The image capturing unit 13 further includes an image processor 131 electrically connected to an image sensor 130 of the lens and a digital I/O 132 electrically connected to the image process unit 131. An analog signal from the image sensor 130 can be transformed to a digital signal by the image processor 131, and the digital signal can be transmitted out by the digital I/O 132. The digital signal can be transmitted to a distant image storage space by the digital I/O 132 via the printed antenna 16. Beside, the digital signal also can be transmitted to an outside image storage space from the first transmitting port 15 via inside wiring. In this embodiment, the image processor 131 and the digital I/O 132 can be disposed on the first circuit board 14 for the above functions. However, the image processor 131 and the digital I/O 132 also can be disposed in locations other than the first circuit board 14 such as inside of mobile device and electronically connected to the first transmitting port 15. Therefore, the signal from the image capturing unit 13 disposed elsewhere is transmitted to the image processor 131 by the first transmitting port 15 and transformed to a digital signal, and the digital signal is transmitted to an assigned storage space by the digital I/O 132 via wire or wireless (such as through printed antenna 16) method.

In this embodiment, the printed antenna 16 is configured to receive a wireless signal conforming the specification of NFC standard, but the printed antenna 16 also can be designed to receive-signals of different frequencies. For example: the antenna can be designed to receive GPS, WI-FI, Bluetooth, WiMax, LTE or FM signal. Beside, in this embodiment, the image capturing device 10 having an antenna comprises the printed antenna 16 spirally surrounding the lens 11. However, the printed antenna 16 is not limited to spiral-form, it can use other shape or form to save space. Alternatively, the printed antenna 16 also can be disposed adjacent to the lens 11 instead of surrounding it. Moreover, in this embodiment, the first circuit board 14 is a flexible printed circuit board, but the first circuit board 14 also can be a rigid printed circuit board instead of a flexible printed circuit board.

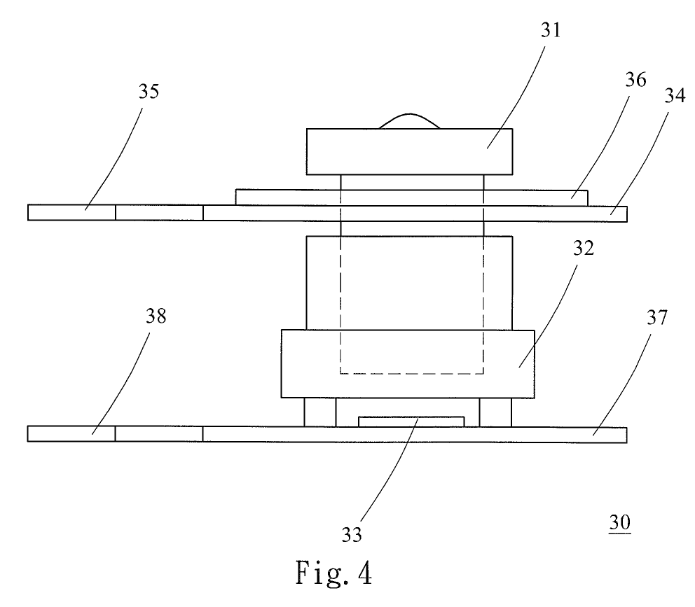

Please refer FIG. 4. FIG. 4 shows a lateral view of the image capturing device 30 having an antenna of another embodiment. The image capturing device 30 having an antenna includes a lens module, a first circuit board 34, a second circuit board 37, a first transmitting port 35, and a second transmitting port 38. The lens module includes a lens 31, a lens holder 32 and an image capturing unit 33, and the first circuit board 34 includes a printed antenna 36.

In this embodiment, the lens 31 and lens holder 32 are disposed on the second circuit board 37, the image capturing unit 33 is connected to the second circuit board 37 via a wire (not drawn in the FIG. 4), and the second circuit board 37 is connected to the second transmitting port 38. The lens 31 is configured to capturing light via optical refraction. The lens holder 32 is disposed on the second circuit board 37 and used to hold the lens 31 in position without shaking. The image capturing unit 33 is disposed between the lens 31 and the second circuit board 37 and the light capturing by lens 31 is transformed into digital image data by the image capturing unit 33. The image data transformed by the image capturing unit 33 can be transmitted to the second circuit board 37 via the wire, and then the image data can be transmitted to the second transmitting port 38 by the circuit of the second circuit board 37. Eventually, the image data is transmitted out by the second transmitting port 38. For example, the image data is transmitted to a storage space of a handheld device (such as a mobile phone), and then the image data is processed by the CPU of the handheld device.

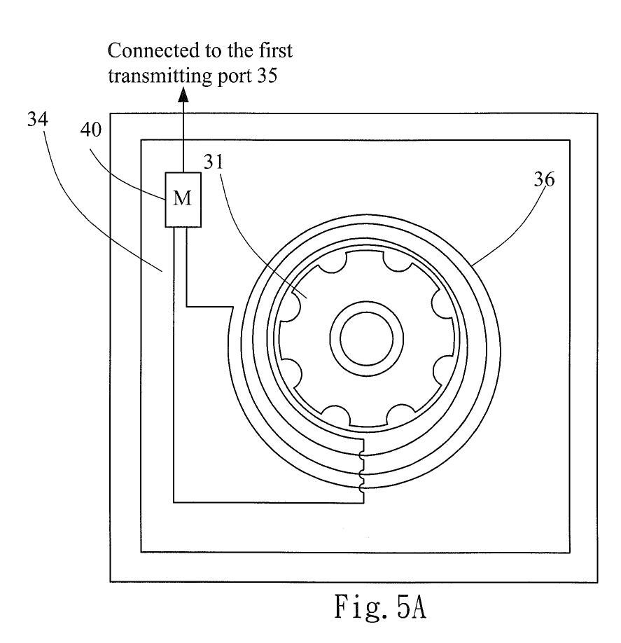

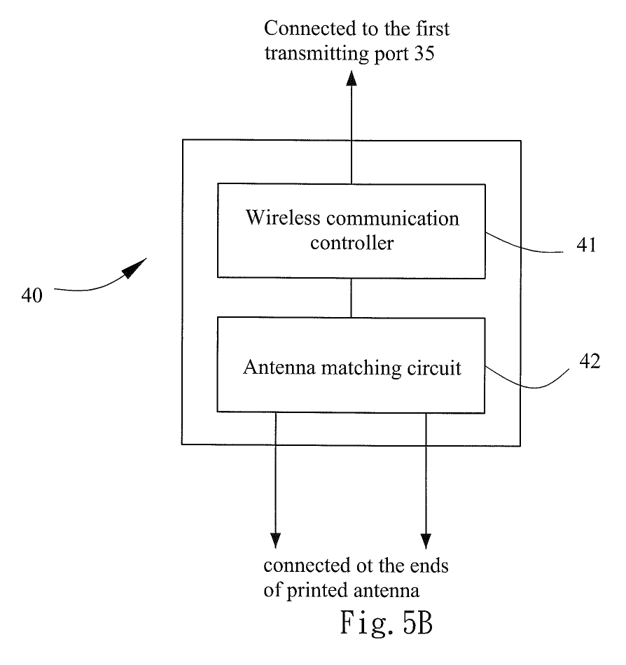

In addition, please refer to FIG. 5A. FIG. 5A shows first circuit board 34. In this embodiment, the first circuit board 34 is disposed on the second circuit board 37, and the first circuit board 34 has a perforation penetrated by the lens 31. The printed antenna 36 and the signal processor 40 are disposed on the first circuit board 34. The printed antenna 36 is spiral-shaped and electrically connected to the signal processor 40, and the lens 31 is surrounded by the printed antenna 36. A signal received by the printed antenna 36 is transmitted to the first circuit board 34, and then the signal is transmitted to the signal processor 40. Next, the signal is transformed and transmitted to the first transmitting port 35 by the signal processor 40, and the transformed signal is transmitted out by the first transmitting port 35.

Please refer FIG. 5B. FIG. 5B shows a detailed architecture chart of the signal processor 40. The signal processor 40 includes a wireless communication controller 41 and an antenna matching circuit 42. An analog signal received by the printed antenna 36 is transformed to a digital signal by the wireless communication controller 41, so the transformed signal can be transmitted out successfully from the first transmitting port 35. Alternatively, a digital signal can be transformed to an analog signal by the wireless communication controller 41, so the printed antenna 36 can exchange the signal with other antennas. The antenna matching circuit 42 is used for impedance matching and can reduce the impedance difference within the antenna, so the antenna matching circuit 42 can make signal transmitting more stable.

In this embodiment, the printed antenna 36 and the signal processor 40 are disposed on the first circuit board 34, and the lens module is disposed on the second circuit board 37. But the present invention is not limited thereto, the printed antenna 36 and the signal processor 40 also can be disposed on the second circuit board 37, and the lens module also can be disposed on the first circuit board 34 as long as the circuit of the circuit board is not affected and image capturing of the lens 31 is not interfered.

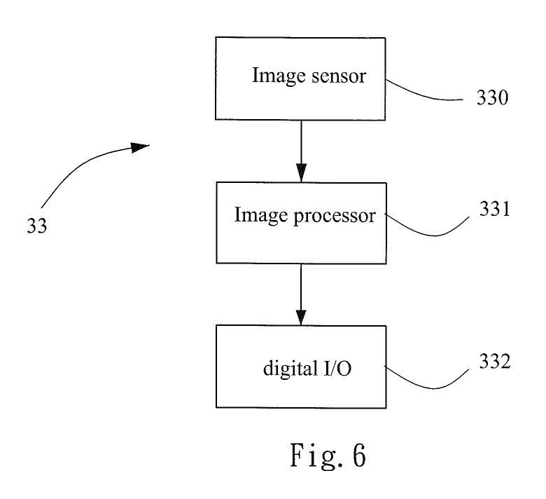

Please refer FIG. 6. FIG. 6 shows an element architecture chart of the image capturing unit 33. The image capturing unit 33 further includes an image processor 331 electrically connected to an image sensor 330 of the lens and a digital I/O 332 electrically connected to the image process unit 331. The analog signal from the image sensor 330 can be transformed to a digital signal by the image processor 331, and then the digital signal can be transmitted out by the digital I/O 332. The digital signal can be transmitted to a distant image storage space by the digital I/O 332 via the printed antenna 36. Alternatively, the digital signal also can be transmitted to an outside image storage space from the first transmitting port 35 via inside wiring. The image processor 331 and the digital I/O 332 can be disposed on the second circuit board 37 for the above functions. The image processor 331 and the digital I/O 332 also can be disposed in locations other than the second circuit board 37 such as inside of a mobile device and electronically connected to the second transmitting port 38. Therefore, the signal from the lens 31 is transmitted to the added-on image processor 40 by the second transmitting port 38 and transformed to a digital signal, and then the digital signal is transmitted to an assigned storage space by the digital I/O via wire or wireless (such as through printed antenna 36) method.

For some traditional mobile devices like PDA that may not have antennas or lack of an antenna of proper frequency and do not have lens, the device of the present invention is very thin and light and can be directly added on the old mobile devices, so the circuit boards of the old mobile devices do not need to be re-designed. It is easy to upgrade the old mobile devices and make them have capturing and wireless network functions.

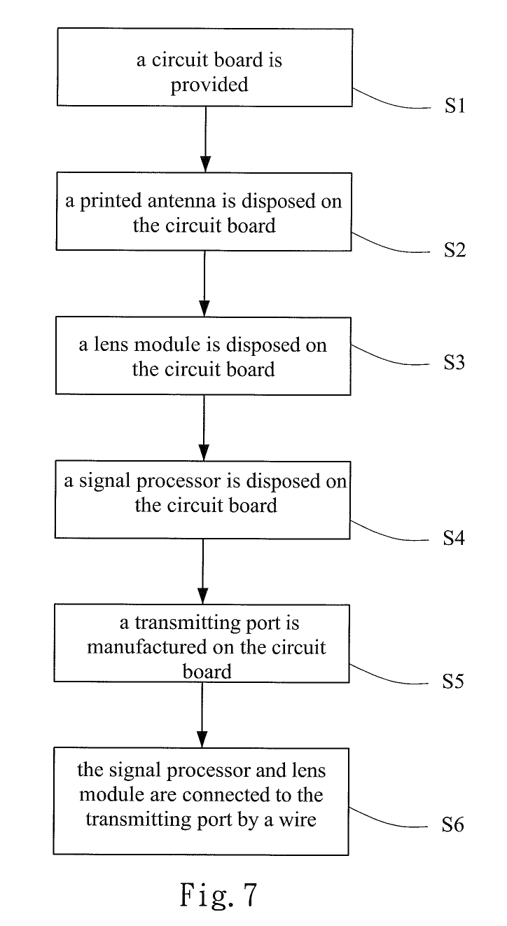

Please refer FIG. 7. FIG. 7 shows an assembly method of the image capturing device having an antenna of present invention. First, a circuit board is provided (step S1), the circuit board can be a flexible printed circuit board or a rigid printed circuit board. Next, a printed antenna is disposed on the circuit board (step S2), the printed antenna is spiral-shaped, and there is a reserved space in the center of the printed antenna. Then, a lens module is disposed on the reserved space of the printed antenna (step S3). Next, a signal processor is disposed on the circuit board (step S4), and the signal processor is disposed on the end of the printed antenna and connected to the printed antenna. Then, a transmitting port is manufactured on the circuit board (step S5). Next, the signal processor and lens module are connected to the transmitting port by a wire (step S6). Therefore, the assembly of the image capturing device having an antenna is completed, next the image capturing device having an antenna can be installed on other electronic devices.

In the prior art, the lens and the antenna are disposed separately, so it needs more time to assembly. However, in the present invention, the lens and the antenna are integrated, so the printed antenna can be installed at the time when the image capturing device having an antenna is disposed. Therefore, the assembly process of mobile devices can be faster, cheaper, and easier. Furthermore, the lens module 11 and the printed antenna 16 are integrated on the first circuit board 14, so they save some space in the mobile device for containing other elements. In addition, the printed antenna 16 of the present invention is disposed on the first circuit board 14, the space adjacent the lens 11 is effectively used. Moreover, the signal and the image data received by the printed antenna 16 both use the first transmitting port 15, so there is no need to dispose other transmitting ports for the printed antenna 16. Therefore, the element designing of mobile device can be substantially easier, and space and cost also can be effectively saved.

Those skilled in the art will readily observe that numerous modifications and alternatives of the device and method may be made while retaining the teachings of the invention. Accordingly, the above disclosure should be construed as limited only by the meters and bounds of the appended claims.

I claim:

1. An image capturing device having an antenna comprising:
a first circuit board;
a lens module, disposed on the first circuit board; and
a printed antenna, disposed on the first circuit board.

2. The image capturing device having an antenna of claim 1, wherein the lens module comprises a lens and a image capturing unit.

3. The image capturing device having an antenna of claim 1, wherein the first circuit board comprises a first transmitting port.

4. The image capturing device having an antenna of claim 1, further comprising a signal processor.

5. The image capturing device having an antenna of claim 1, wherein the printed antenna surrounds the lens module.

6. The image capturing device having an antenna of claim 1, wherein the printed antenna is deposed adjacent to the lens module.

7. The image capturing device having an antenna of claim 2, wherein the image capturing unit comprises:
an image processing unit, electrically connected to an image sensor;
a digital I/O, electrically connected to the image processing unit.

8. The image capturing device having an antenna of claim 4, wherein the signal processor comprises a wireless communication controller and an antenna matching circuit.

9. The image capturing device having an antenna of claim 1, wherein the the printed antenna is configured to receive a wireless signal conforming the specification of NFC, RFID, WI-FI, Bluetooth, WiMax or LTE standard.

10. The image capturing device having an antenna of claim 1, wherein the first circuit board is a flexible circuit board.

11. An image capturing device having an antenna comprising:
a first circuit board;
a second circuit board;
a lens module, disposed on the second circuit board; and
a printed antenna, disposed on the first circuit board.

12. The image capturing device having an antenna of claim 11, wherein the first circuit board is disposed on the second circuit board.

13. The image capturing device having an antenna of claim 11, wherein the first circuit board comprises a perforation.

14. The image capturing device having an antenna of claim 11, wherein the lens module comprises a lens and an image capturing unit.

15. The image capturing device having an antenna of claim 11, wherein the first circuit board comprises a first transmitting port.

16. The image capturing device having an antenna of claim 11, wherein the second circuit board comprise a second transmitting port.

17. The image capturing device having an antenna of claim 11, wherein the printed antenna comprises a signal processor.

18. The image capturing device having an antenna of claim 11, wherein the printed antenna surrounds the lens module.

19. The image capturing device having an antenna of claim 11, wherein the printed antenna is deposed adjacent to the lens module.

20. The image capturing device having an antenna of claim 14, wherein
the image capturing unit comprises:
an image processing unit, electrically connected to an image sensor;
a digital I/O, electrically connected to the image processor.

21. The image capturing device having an antenna of claim 17, wherein the signal processor comprises a wireless communication controller and an antenna matching circuit.

22. The image capturing device having an antenna of claim 11, wherein the printed antenna is configured to receive a wireless signal conforming the specification of NFC, RFID, WI-FI, Bluetooth, WiMax or LTE standard.

23. The image capturing device having an antenna of claim 11, wherein the first circuit board or second circuit board is a flexible circuit board.

24. A method of assembling an image capturing device having an antenna, comprising:
A. providing a circuit board;
B. disposing a printed antenna on the circuit board;
C. disposing a lens module on the circuit board;

25. The method of claim 24, further comprising the following step:
D. disposing a signal processor on the circuit board.

26. The method of claim 24, further comprising the following step:
E. manufacturing a transmitting port on the circuit board.

27. The method of claim 24, further comprising the following step:
F. connecting the signal processor and the lens module to the transmitting

28. The method of claim 24, wherein the lens module further comprises an image sensor.

29. The method of claim 24, wherein the lens module is surrounded by the printed antenna.
